(19) United States
(12) Patent Application Publication
(10) Pub. No.: US 2025/0061521 A1
(43) Pub. Date: Feb. 20, 2025

(54) COMPREHENSIVE FINANCIAL MANAGEMENT SYSTEM USING ENTERPRISE RESOURCE MANAGEMENT PROGRAM

(71) Applicant: SEOJIN Consulting network solution Co,. Ltd., Cheongju-si (KR)

(72) Inventor: Jaeyoung KIM, Cheongju-si (KR)

(73) Assignee: SEOJIN Consulting network solution Co,. Ltd., Cheongju-si (KR)

(21) Appl. No.: 18/889,389

(22) Filed: Sep. 19, 2024

Related U.S. Application Data
(63) Continuation of application No. PCT/KR2023/017194, filed on Nov. 1, 2023.

(30) Foreign Application Priority Data
Jul. 4, 2023 (KR) 10-2023-0086415

(51) Int. Cl. G06Q 40/12

(52) U.S. Cl. CPC G06Q 40/12

(57) ABSTRACT

A comprehensive financial management system includes a first financial information collector configured to receive first financial information about deposit and withdrawal details for each preset account from a bank server and convert the first financial information into a database, a second financial information collector configured to receive second financial information about approval details for each preset card from a card company server and convert the second financial information into a database, a third financial information collector configured to receive third financial information about details of electronic tax invoices, electronic invoices, and cash receipts that are supplied or received based on a pre-set management business operator from the National Tax Service server and convert the third financial information into a database.

### BACKGROUND OF THE INVENTION

The present invention relates to a comprehensive financial management system having an automatic slip processing function and a computer-implemented financial information management calendar provision function using an enterprise resource management program.

Enterprise resource planning (ERP) is called enterprise resource management and may be an integrated information system that serves to ultimately reinforce a company's competitiveness by efficiently managing all human and material resources in a company used for corporate activities.

Many large domestic construction companies has introduced an ERP system that synthesizes information based on a commerce at light speed/electronic commerce (CALS/EC) system to secure competitiveness by saving the cost through a the need in order to establish new concept of global strategic resource management and supplier and the systematic management inside the corporate in rapidly changing corporate environments of domestic and international construction markets and market environment of an infinite competition system.

According to a study that divided the effects of the ERP system introduction performed by focusing on companies that introduced construction ERP systems into quantitative and qualitative factors and compared and analyzed the effects of ERP system introduction, it was found that the introduction of the ERP system has a positive impact on the management performance of construction companies.

A program provided to establish such an ERP system has a detailed internal system for providing various functions, and for example, detailed systems for increasing an administrator's convenience in managing and analyzing the slip are being developed in any of various forms.

For example, Korean Patent Application Laid-Open No. 10-2010-0074594 as the reference on the related art provided to provide an automatic payment function in an accounting process of resolutions and slips based on the ERP system discloses an expenditure resolution management method of linking groupware with the ERP system, and a device (hereinafter referred to as “related art”) for performing the same.

However, technologies related to providing the slip management function based on the conventional ERP systems including the related art simply have electronically documented the registered slips and have allowed information reading and payment to be made within a communication network through link between a terminal and a server, and thus there has been a problem that verification and error analysis of the information related to the slips actually processed into information could not be performed, which has greatly affected the reliability and efficiency of the work.

### SUMMAMRY OF THE INVENTION

The present invention has been made in efforts to solve the above problem and is directed to providing a technology that can effectively prevent financial accidents accordingly by quickly detecting errors of slip information through mutual information comparison analysis after separately performing an automated process through link with a bank server, a credit card company server, a National Tax Service server and an input generation process through an administrator's input for slip registration in providing a slip management function based on an enterprise resource planning function system, and can allow the administrator to easily check various pieces of financial information about transaction histories and difference of bank accounts and slips using a calendar.

To achieve the object, a comprehensive financial management system provided by an enterprise resource planning (ERP) program installable on an administrator computer according to the present invention includes a first financial information collector configured to receive first financial information about deposit and withdrawal details for each preset account from a bank server preset and linked to receive information and convert the first financial information into a database, a second financial information collector configured to receive second financial information about approval details for each preset card from a card company server preset and linked to receive information and convert the second financial information into a database, a third financial information collector configured to receive third financial information about details of electronic tax invoices, electronic invoices, and cash receipts that are supplied or received based on a pre-set management business operator from the National Tax Service server preset and linked to receive information and convert the third financial information into a database, an automatic generation type slip information generator configured to generate first automatic generation type slip information including information about a transaction amount and a balance after transaction corresponding to one of a bank name, an account number, a transaction date, a transaction time, a customer name, a withdrawal amount, or deposit amount based on the first financial information collected through the first financial information collector, generate second automatic generation type slip information including information about a transaction date, a customer name, a business registration number, and an approval amount based on the second financial information collected through the second financial information collector, generate third automatic generation type slip information including information about an invoice issuance date, a customer name, a business registration number, and a total amount based on the third financial information about details of electronic tax invoices collected through the third financial information collector, generate fourth automatic generation type slip information including information about an invoice issuance date, a customer name, a business registration number, and a total amount based on the third financial information about the details of the electronic tax invoices collected through the third financial information collector, and generate fifth automatic generation type slip information including information about a cash receipt date, a customer name, a business registration number, and a purchase amount based on the third financial information about details of cash receipts collected through the third financial information collector, an input generation type slip information generator configured to generate input generation type slip information including information about a first slip type corresponding to one of income or expenditure, a slip date, a payment method, a second slip type classified according to a tax type, a customer name, a transaction amount corresponding to one of income or expenditure, deposit and withdrawal transaction dates, an account subject, a construction name, a site name, and a summary based on a signal input by an input device of the administrator computer, and a slip information matching unit configured to perform a matching operation for pieces of slip information in which pieces of information about customer names in a preset period are matched in each of a first slip type between the input generation type slip information in which the payment method by the second slip type among the first automatic generation type slip information and the input generation type slip information is an item related to bank transaction, a second slip type between the input generation type slip information in which the payment method by the second slip type among the second automatic generation type slip information and the input generation type slip information is an item related to card payment, a third slip type between the input generation type slip information in which the tax type by the second slip type among the third automatic generation type slip information and the input generation type slip information is an item related to an electronic tax invoice, a fourth slip type between the input generation type slip information in which the tax type by the second slip type among the fourth automatic generation type slip information and the input generation type slip information is an item related to an electronic invoice, and a fifth slip type between the input generation type slip information in which the tax type by the second slip type among the fifth automatic generation type slip information and the input generation type slip information is an item related to the cash receipt.

Here, the slip information matching unit includes a first customer name word processor configured to perform word processing that connects all letters by ignoring a spacing of each of the customer name included in the first automatic generation type slip information to the fifth automatic generation type slip information generated through the automatic generation type slip information generator and the customer name included in the input generation type slip information generated through the input generation type slip information generator, a second customer name word processor configured to perform word processing that excludes letters of Co., Ltd., Co., Ltd., (solidarity), general partnership, (limited), limited company, (company), incorporated association, (foundation), incorporated foundation, (agricultural), and agricultural corporation from each of the customer names whose spacing has been ignored through the first customer name word processor, and a slip information automatic matcher configured to match the first automatic generation type slip information to the fifth automatic generation type slip information with the input generation type slip information each of which consecutive identical letters are a preset matching reference number or more based on each of the customer name whose specific letters have been excluded through the second customer name word processor 162 and perform information processing separately according to the number of slips matched, and as a case where the number of slips matched as the result of matching is 1, the slip information automatic matcher generates matching end slip information by pairing a pair of one of the first automatic generation type slip information to the fifth automatic generation type slip information and one of the input generation type slip information, which are matched as 1:1.

In addition, as a case where the number of slips matched as the result of matching is 2 or more, the slip information automatic matcher generates first manual matching slip information by pairing a plurality of pieces of information in which a plurality of pieces of the first automatic generation type slip information to the fifth automatic generation type slip information and one of the input generation type slip information are matched or one of the first automatic generation type slip information to the fifth automatic generation type slip information and a plurality of pieces of the input generation type slip information are matched, and the slip information matching unit further includes a first slip information manual matcher configured to convert paired information into the matching end slip information by pairing the pair of one corresponding to a matching target selection signal of the first automatic generation type slip information to the fifth automatic generation type slip information and one corresponding to the matching target selection signal of the input generation type slip information in the first manual matching slip information based on the matching target selection signal input by the input device of the administrator computer, which are matched as 1:1.

In addition, as a case where the number of slips matched as the result of matching is zero, the slip information automatic matcher does not match the first automatic generation type slip information to the fifth automatic generation type slip information and the input generation type slip information, but generates second manual matching slip information by pairing a pair of one of the first automatic generation type slip information to the fifth automatic generation type slip information and one of the input generation type slip information, which are matched as 1:1, in which information about the amount corresponding to one of the transaction amount, the approval amount, the total amount, or the purchase amount included in the first automatic generation type slip information to the fifth automatic generation type slip information matches the information about the transaction amount included in the input generation type slip information.

According to the present invention, the effects are as follows.

First, in providing the slip management function based on the enterprise resource management system, it is possible to quickly detect errors of the slip information through mutual information comparison analysis after separately performing the automated process through the link with the bank server, the credit card company server, the National Tax Service server and the input generation process through the administrator's input for slip registration in providing the slip management function based on the enterprise resource planning function system.

Second, it is possible to quickly identify the occurrence of errors of the slip information and immediately respond to and correct the errors, thereby minimizing and effectively preventing various financial accidents due to the registration error of the slip information.

Third, it is possible to allow the administrator to easily identify and analyze various pieces of financial information about the transaction histories and difference of the bank accounts and the registered slips using the calendar.

### BRIEF DESCRIPTION OF THE DRAWINGS

FIG. 1 is a configuration diagram of a comprehensive financial management system according to the present invention.

FIG. 2 is a block diagram showing the comprehensive financial management system according to the present invention.

FIG. 3 is a view for describing a format in which comparison information generated through a comparison information generator in the comprehensive financial management system according to the present invention is output and reflected in the slip information comparison output platform provided by the enterprise resource management program.

FIGS. 4 and 5 are views for describing a format of a financial information management calendar generated through a management calendar provision unit in the comprehensive financial management system according to the present invention.

FIGS. 6 to 8 are views for describing an information display format for each column of the financial information management calendar generated through the management calendar provision unit in the comprehensive financial management system according to the present invention.

### DETAILED DESCRIPTION OF THE INVENTION

Exemplary embodiments of the present invention will be described in more detail with reference to the accompanying drawings, and already well-known technical parts will be omitted or simplified for brief description.

### <Descriptions of Components and Functional Types of Comprehensive Financial Management System>

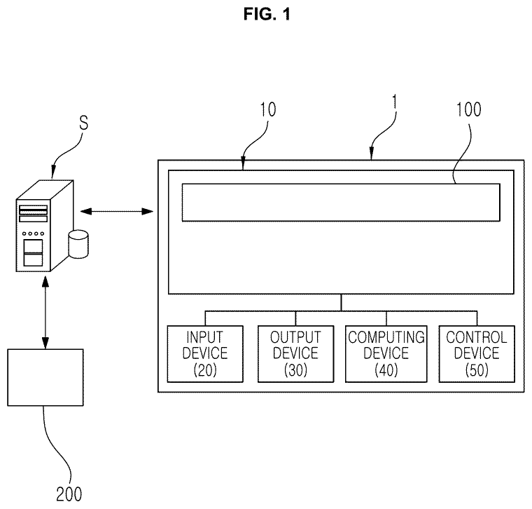

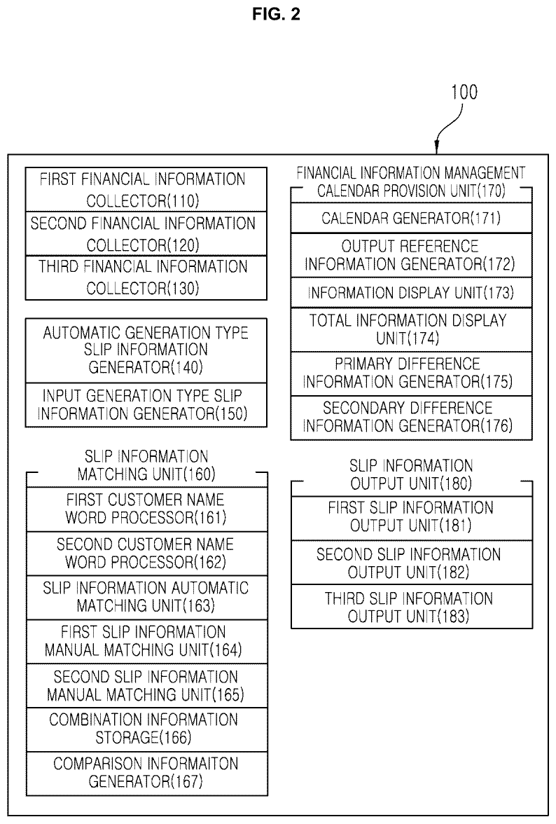

First, a comprehensive financial management system 100 according to the present invention provided by an enterprise resource planning (ERP) program implemented by being installed on an administrator computer 1 will be described in detail below with reference to a configuration diagram and a block diagram of FIGS. 1 and 2.

To this end, as shown in FIGS. 1 and 2, the comprehensive financial management system 100 according to the present invention includes a first financial information collector 110, a second financial information collector 120, a third financial information collector 130, an automatic generation type slip information generator 140, an input generation type slip information generator 150, a slip information matching unit 160, a financial information management calendar provision unit 170, and a slip information output unit 180.

First, the comprehensive financial management system 100 may be provided by the ERP program implemented after being installed inside the administrator computer 1, may have a form of a system whose each component serves as a module, and may be provided in the form of a program so that each component performs detailed functions of the program.

Specifically, the comprehensive financial management system 100 may be installed in the form of a program in a storage device 10 inside the administrator computer 1 to build a system and perform mutual transmission and reception of signal and data by building an interface so as to be linked with an input device 20, an output device 30, a calculation device 40, and a control device 50.

For example, when the administrator inputs a specific signal through the input device 20 such as a keyboard and a mouse, the specific signal is transmitted to the comprehensive financial management system 100 and linked to the progress of a specific operation or the performance of a specific function.

In addition, when the progress of the specific step or the performance of the specific function is made from the comprehensive financial management system 100, these may be transmitted to the output device 30, such as a display, to visually output the information.

In addition, according to an embodiment, the comprehensive financial management system 100 may be construed as a program itself installed in the storage device 10 inside the administrator computer 1, but is not limited thereto.

The first financial information collector 110 receives first financial information about deposit and withdrawal details for each preset account from a bank server preset and linked to receive information and converts the first financial information into a database.

The administrator uses the ERP program installed on the administrator computer 1 to finish an authentication process in advance so that linkage with the bank server is finished for each bank account subjected to the administrator's financial management.

As described above, at least one bank account information that has been linked to the bank server is displayed separately by account number and bank company.

The second financial information collector 120 receives second financial information about approval details for each preset card from a card company server that is preset and linked to receive information and converts the second financial information into a database.

The administrator uses the ERP program installed on the administrator computer 1 to finish an authentication process in advance so that linkage with the card company server is finished for each card subjected to the administrator's financial management in advance.

As described above, at least one card information that has been linked to the card company server is displayed separately by card number and card company.

The third financial information collector 130 receives third financial information about details of electronic tax invoices, electronic invoices, and cash receipts that are supplied or received based on a pre-set management business operator from the National Tax Service server preset and linked to receive the information and converts the third financial information into a database.

The administrator uses the ERP program installed on the administrator computer 1 to finish an authentication process in advance so that linkage with the National Tax Service server is finished for each management business operator subjected to the administrator's financial management in advance.

The automatic generation type slip information generator 140 generates automatic generation type slip information using pieces of financial information collected through the first financial information collector 110, the second financial information collector 120, and the third financial information collector 130.

Specifically, the automatic generation slip information generator 140 generates first automatic generation type slip information including information about a bank name, an account number, a transaction date, a transaction time, a customer name, a transaction amount corresponding to one of withdrawal amounts and deposit amounts, and a balance after the transaction based on the first financial information collected through the first financial information collector 110.

The generated first automatic generation type slip information may be output to an area partitioned into financial information A in a slip information comparison output platform (output reference: bank) provided as shown in by the ERP program installed on the administrator computer 1 through a first slip information output unit 181 included in a slip information output unit 180 so that the administrator may recognize contents of the corresponding information.

In addition, the automatic generation type slip information generator 140 generates second automatic generation type slip information including information about a transaction date, a customer name, a business registration number, and approval amounts based on the second financial information collected through the second financial information collector 120.

The generated second automatic generation type slip information may be output to the area partitioned into the financial information A in the slip information comparison output platform (output reference: card) provided by the ERP program installed on the administrator computer 1 through the first slip information output unit 181 so that the administrator may recognize contents of the corresponding information.

In addition, the automatic generation type slip information generator 140 generates third automatic generation type slip information including information about an invoice issuance date, a customer name, a business registration number, and a total amount based on the third financial information about details of the electronic tax invoice collected through the third financial information collector 130.

The generated third automatic generation type slip information may be output to the area partitioned into the financial information A in the slip information comparison output platform (output reference: electronic tax invoice) provided by the ERP program installed on the administrator computer 3 through the first slip information output unit 181 so that the administrator may recognize contents of the corresponding information.

In addition, the automatic generation type slip information generator 140 generates fourth automatic generation type slip information including information about an invoice issuance date, a customer name, a business registration number, and a total amount based on the third financial information about details of the electronic tax invoice collected through the third financial information collector 130.

Lastly, the automatic generation type slip information generator 140 generates fifth automatic generation type slip information including information about a cash receipt date, an account name, a business registration number, and a purchase amount based on the third financial information about cash receipt details collected through the third financial information collector 130.

The generated fifth automatic generation type slip information may be output to the area partitioned into the financial information A in the slip information comparison output platform (output reference: cash receipt) provided by the ERP program installed on the administrator computer 1 through the first slip information output unit 181 so that the administrator may recognize contents of the corresponding information.

The input generation type slip information generator 150 generates input generation type slip information including information about a first slip type corresponding to one of income or expenditure, a slip date, a payment method, a second slip type classified according to a tax type, a customer name, a transaction amount corresponding to one of income or expenditure, deposit and withdrawal transaction dates, an account subject, a construction name, a site name, and a summary based on a signal input by the input device 20 of the administrator computer 1.

Specifically, the administrator performs the work to generate the signal through the input device 20 so that the information about a first slip type corresponding to one of income or expenditure, a slip date, a payment method, a second slip type classified according to a tax type, a customer name, a transaction amount corresponding to one of income or expenditure, deposit and withdrawal transaction dates, an account subject, a construction name, a site name, and a summary may be input and generated by using the ERP program installed on the administrator computer 1.

Here, the payment method of the slip for classifying the second slip type may be performed to be selected from preset items, such as cash/transfer, card, bill, credit, discount, and replacement, and the tax type of the slip for classifying the second slip type may be selected among preset items such as a simple receipt, an invoice (taxation), an invoice (tax exemption), an invoice (zero tax), a card slip (taxation), a card slip (tax exemption), a cash receipt (taxation), a personal invoice (taxation), a personal invoice (tax exemption), and unissued.

As described above, the input generation type slip information generated by performing information input work directly by the administrator through the input device 20 may be output to an area partitioned into slip registration B in the slip information comparison output platform provided by the ERP program installed on the administrator computer 1 through a second slip information output unit 182 included in the slip information output unit 180 to allow the administrator to recognize contents of the corresponding information and allow comparison with the automatic generation type slip information displayed on the area partitioned into the financial information A to be performed at once.

The slip information matching unit 160 performs the matching operation so that one of the first automatic generation type slip information to the fifth automatic generation type slip information generated through the automatic generation type slip information generator 140 may match one of pieces of the input generation type slip information generated through the input generation type slip information generator 150.

Specifically, the slip information matching unit 160 performs the matching operation for pieces of slip information in which pieces of information about customer names in a preset period are matched in each of a first slip type between the input generation type slip information in which the payment method by the second slip type among the first automatic generation type slip information and the input generation type slip information is an item (when the cash/transfer item is selectively input) related to bank transaction, a second slip type between the input generation type slip information in which the payment method by the second slip type among the second automatic generation type slip information and the input generation type slip information is an item (when the card item is selectively input) related to card payment, a third slip type between the input generation type slip information in which the tax type by the second slip type among the third automatic generation type slip information and the input generation type slip information is an item related to an electronic tax invoice, a fourth slip type between the input generation type slip information in which the tax type by the second slip type among the fourth automatic generation type slip information and the input generation type slip information is an item related to an electronic invoice, and a fifth slip type between the input generation type slip information in which the tax type by the second slip type among the fifth automatic generation type slip information and the input generation type slip information is an item (when the cash receipt (taxation) is selectively input) related to the cash receipt.

To this end, the slip information matching unit 160 includes a first customer name word processor 161, a second customer name word processor 162, a slip information automatic matcher 163, a first slip information manual matcher 164, a second slip information manual matcher 165, a combination information storage 166, and a comparison information generator 167.

Here, the first customer name word processor 161 performs word processing connecting all letters by ignoring a spacing of each of the customer name included in the first automatic generation type slip information to the fifth automatic generation type slip information generated through the automatic generation type slip information generator 140 and the customer name included in the input generation type slip information generated through the input generation type slip information generator 150.

For example, the first customer name word processor 161 performs the word processing that attaches all letters like “DaehanJaeilConstructionCo.,Ltd.” in order when the customer name included in the first automatic generation type slip information to the fifth automatic generation type slip information generated through the automatic generation type slip information generator 140 is “Daehan Jaeil Construction Co., Ltd.”

In this regard, the second customer name word processor 162 perform word processing that excludes letters of Co., Ltd., Co., Ltd., (solidarity), general partnership, (limited), limited company, (company), incorporated association, (foundation), incorporated foundation, (agricultural), and agricultural corporation from each of the customer names whose spacing has been ignored through the first customer name word processor 161.

For example, when the customer name included in the input generation type slip information generated through the input generation type slip information generator 150 is “Woori General Construction Co., Ltd.,” the word processing is performed to output “WooriGeneralConstructionCo.,Ltd.” through the first customer name word processor 161, and then the word processing is performed to output “WooriGenerationConstruction” by deleting the word Co.,Ltd. through the second customer name word processor 162.

Next, the slip information automatic matcher 163 matches the first automatic generation type slip information to the fifth automatic generation type slip information with the input generation type slip information each of which consecutive identical letters are a preset matching reference number or more based on each of the customer name whose specific letters have been excluded through the second customer name word processor 162 and performs information processing separately according to the number of slips matched.

For example, in case that the customer name included in the first automatic generation type slip information to the fifth automatic generation type slip information generated through the automatic generation type slip information generator 140 is “A T S General Construction Co., Ltd.” and the customer name included in the input generation type slip information generated through the input generation type slip information generator 150 is “ATS General Co., Ltd.,” when the work processing is performed to output the “ATSGeneralConstructionCo.,Ltd.” and “ATSGeneralCo.,Ltd.” through the first customer name work processor 161, then the word “Co., Ltd.” is deleted through the second customer name word processor 162 to perform the word processing to output “ATSGeneralConstruction” and “ATSGeneral,” 7 letters of “ATSGeneral” are identical as the result of matching determination through the slip information automatic matcher 163, and thus a pair of two slip information reflecting each customer name is matched.

As described above, the number of matching cases in the process that the slip information matching between a first group of the first automatic generation type slip information to the fifth automatic generation type slip information and a second group of the input generation type slip information is performed through the slip information automatic matcher 163 based on the customer name is largely divided into 0, 1, and 2 or more.

First, when the number of slips matched as the result of matching is 1, the slip information automatic matcher 163 generates matching end slip information by pairing a pair of one of the first automatic generation type slip information to the fifth automatic generation type slip information that correspond thereto and one of the input generation type slip information, which are matched as 1:1.

Since the generated matching end slip information is output by being consecutively displayed together with information indicating that the number of slips matched as the result of matching is 1 through the third slip information output unit 183 included in the slip information output unit 180 in the slip information registration platform provided by the EPR program installed on the administrator 1 in a state in which one of the first automatic generation type slip information to the fifth automatic generation type slip information and one of the input generation type slip information whose matching have been ended have been paired, when it is determined that the matching is normal after the administrator recognizes and inspects the content of the corresponding information, informatization and databaseization through final registration of the slip information may be achieved through the ERP program.

In contrast, when the number of slips matched as the result of matching is 2 or more, the slip information automatic matcher 163 generates first manual matching slip information by pairing a plurality of pieces of information in which a plurality of pieces of the first automatic generation type slip information to the fifth automatic generation type slip information and one of the input generation type slip information are matched or one of the first automatic generation type slip information to the fifth automatic generation type slip information and a plurality of pieces of the input generation type slip information are matched.

In this regard, the first slip information manual matcher 164 converts paired information int the matching end slip information by pairing the pair of one corresponding to a matching target selection signal of the first automatic generation type slip information to the fifth automatic generation type slip information and one corresponding to the matching target selection signal of the input generation type slip information in the first manual matching slip information based on the matching target selection signal input by the input device 20 of the administrator computer 1, which are matched as 1:1.

Specifically, since the first manual matching slip information generated through the slip information automatic matcher 163 is output by being consecutively displayed together with information indicating that the number of slips matched as the result of matching is 2 through the third slip information output unit 183 in the slip information registration platform provided by the EPR program installed on the administrator program 1 in a state in which a plurality of pieces of the first automatic generation type slip information to the fifth automatic generation type slip information and one of the input generation type slip information have been paired or a state in which one of the first automatic generation type slip information to the fifth automatic generation type slip information and a plurality of pieces of the input generation type slip information have been paired, information is provided to allow the administrator to recognize the content of the corresponding information and then compare and determine which information is correct matched information among the paired plurality of pieces of first automatic generation type slip information to the fifth automatic generation type slip information or the paired plurality of pieces of input generation type slip information.

After such a comparison and determination process is performed, the administration selects specific information by using the input device 20 of the administrator computer 1 to generate the matching target selection signal, and the paired information may become the matching end slip information by pairing a pair of one corresponding to the matching target selection signal of the first automatic generation type slip information to the fifth automatic generation type slip information and one corresponding to the matching target selection signal of the input generation type slip information, which are matched as 1:1, and thus when the administrator recognizes and inspect the content of the corresponding converted information and then determines that the matching is normal, informatization and databaseization through the final registration of the slip information may be achieved through the ERP program.

Next, when the number of slips matched as the result of matching is zero, the slip information automatic matcher 163 does not match the first automatic generation type slip information to the fifth automatic generation type slip information and the input generation type slip information, but generates second manual matching slip information by pairing a pair of one of the first automatic generation type slip information to the fifth automatic generation type slip information and one of the input generation type slip information, which are matched as 1:1, in which information about the amount corresponding to one of the transaction amount, the approval amount, the total amount, or the purchase amount included in the first automatic generation type slip information to the fifth automatic generation type slip information matches the information about the transaction amount included in the input generation type slip information.

For example, the transaction data included in the first automatic type slip information generated through the automatic generation type slip information generator 140 is “April 10,” the customer name is “Hong Gil Dong,” and the transaction amount is “220000 won,” and the slip date included in the input generation type slip information generated through the input generation type slip information generator 150 is “April 11,” the customer name is “JaeIl Construction Co., Ltd.,” and the transaction amount is “220000 won (import),” the matching based on the customer name is not performed because the number of slips is zero, but the transaction amounts are matched within a preset period, and thus the pieces of slip information are paired and then generated as the second manual matching slip information.

In this regard, the second slip information manual matcher 165 converts the second manual matching slip information corresponding to a matching approval signal based on the matching approval signal input by the input device 20 of the administrator computer 1.

Subsequent to the above description, the second manual matching slip information is output by being consecutively displayed together with information indicating that the number of slips matched at the result of matching is zero through the third slip information in the slip information registration platform provided by the ERP program installed on the administrator computer 1 in the state in which the first automatic generation type slip information in which the transaction data is “April 10,” the customer name is “Hong Gil Dong,” and the transaction amount is “220000 won” and the input generation type slip information in which the slip date is “April 11,” the customer name is “Jaeil Construction Co., Ltd.,” and the transaction amount is “220000 won (import),” have been paired.

In addition, the combination information storage 166 generates and stores, as matchable customer name combination information, the customer name included in one of the first automatic generation type slip information to the fifth automatic generation type slip information and the customer name included in one of the input generation type slip information, which correspond to information target generated by being converted into the matching end slip information from the second manual matching slip information through the second slip information manual matcher 165.

Subsequent to the above description, when the conversion processing of the second manual matching slip information into the matching end slip information through the second slip information manual matcher 165 has been ended once, the combination information storage 166 generates and then stores the customer name “Hong Gil Dong” and the customer name “JaeIl Construction Co., Ltd.” as the matchable customer name combination information indicating that the above customer names may be matched.

Therefore, even when consecutive identical letters are not the preset matching reference number or more based on each customer name whose specific letters are excluded through the second customer name word processor 162, the slip information automatic matcher 163 generates the matching end slip information by pairing the pair of one of the first automatic generation type slip information to the fifth automatic generation type slip information and one of the input generation type slip information, which are matched as 1:1, each including the information about the customer name corresponding to the matchable customer name combination information stored in the combination information storage 166.

Subsequent to the above description, as the matchable customer name combination information indicating “Hong Gil Dong-JaeIl Construction Co., Ltd” is generated through the combination information storage 166, when the customer name according to one of the first automatic generation type slip information to the fifth automatic generation type slip information corresponding to the second or more rounds later is “Hong Gil Dong or JaeIl Construction Co., Ltd.” and the customer name according to one of the input generation type slip information is “JaeIl Construction Co., Ltd. or Hong Gil Dong,” the matching according to the customer name is not performed, but a pair of the two pieces of slip information are paired to be converted into the matching end slip information.

This is for allowing the matching to be automatically performed after the matching is manually performed on the first round even when the customer name is used as the representative name and used as the company name.

Lastly, the comparison information generator 167 generates comparison information including information about a comparison difference of the total amount of the input generation type slip information that does not match the individual amount of each of the automatic generation type slip information not matched by slip type, the total amount of the automatic generation type slip information, the individual transaction amount of each of the input generation type slip information not matched by slip type, the total amount of the input generation type slip information not matched by slip type, and the total amount of the automatic generation type slip information not matched by slip type based on information about the amount corresponding to one of the transaction amount, the approval amount, the total amount, or the purchase amount included in the first automatic generation type slip information to the fifth automatic generation type slip information and information about the transaction amount included in the input generation type slip information, which correspond to a case where the number of slips matched as the result of matching through the slip information automatic matcher 163 is zero.

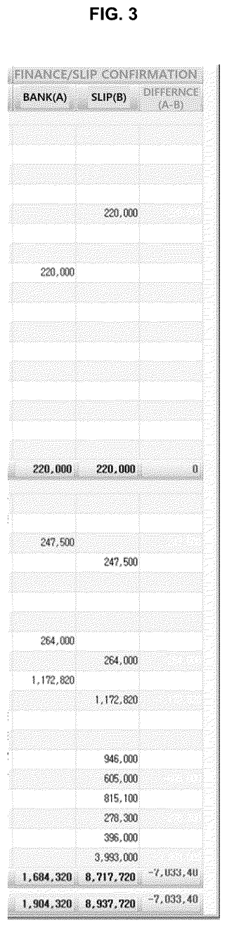

Specifically, the administrator may recognize and compare comparison information by displaying the comparison information in an area marked as “financial/slip check” at the rightmost side through the third slip information output unit 183 in the slip information comparison output platform provided by the ERP program installed on the administrator computer 1, and as shown in the enlarged view of FIG. 3, the individual amount of each automatic generation type slip information not matched by slip type is output by being reflected in a column marked as Bank A, and the total amount of the automatic generation type slip information not matched by slip type is output by being reflected in the lowermost portion of the corresponding column through the third slip information output unit 183.

In addition, as shown in the enlarged view of FIG. 3, the individual transaction amount of each of the input generation type slip information not matched by slip type is output by being reflected in a column marked as Slip B, and the total amount of the input generation type slip information not matched by slip type is output by being reflected in the lowermost portion of the corresponding column through the third slip information output unit 183.

In addition, as shown in the enlarged view of FIG. 3, information about the difference amount of the total amount of the automatic generation type slip information not matched by slip type and the total amount of the input generation type slip information not matched by slip type is output by being reflected in a column marked as Difference (A-B) through the third slip information output unit 183.

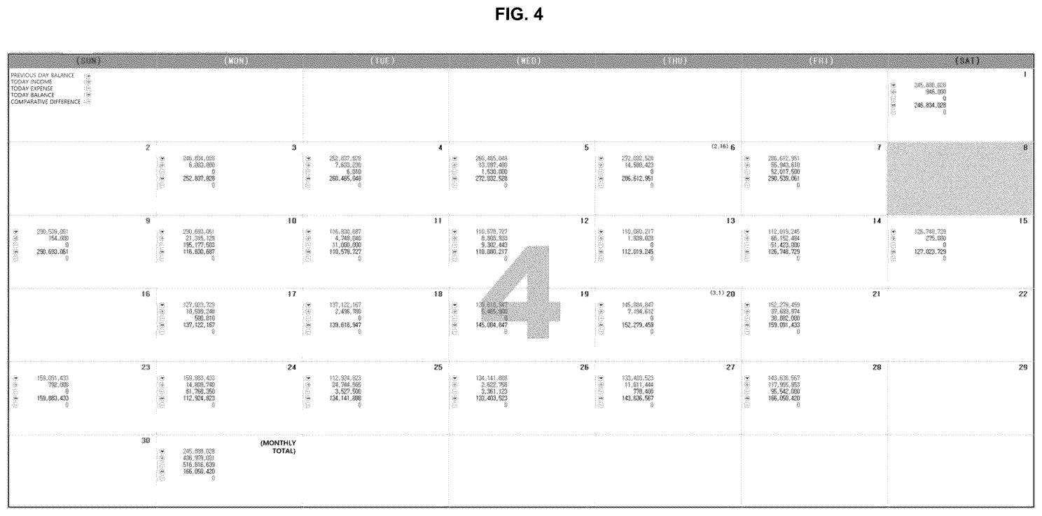

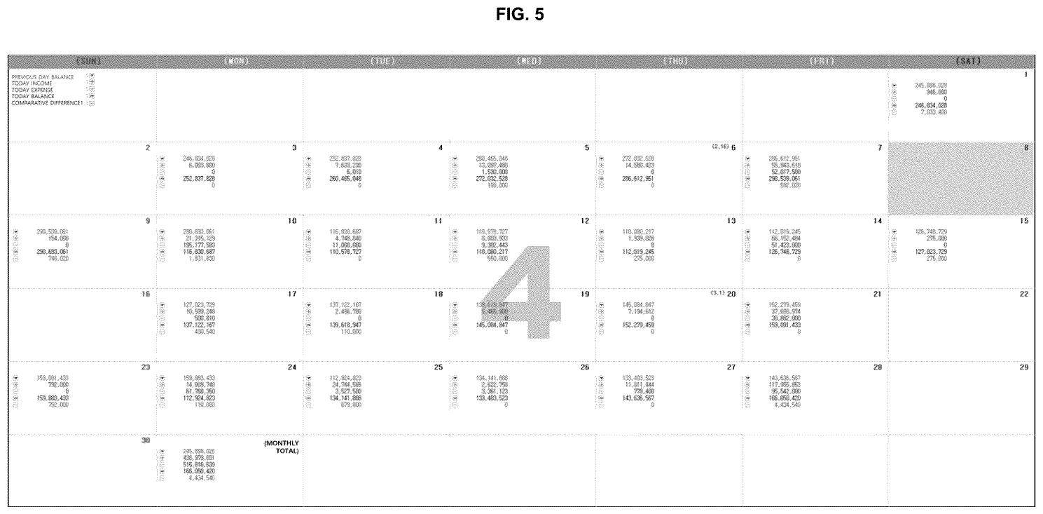

The financial information management calendar provision unit 170 outputs and provides the calendar marked to allow the first automatic generation type slip information generated through the automatic generation type slip information generator 140 to correspond to the transaction date in the first automatic generation type slip information by date in the calendar as shown in FIGS. 4 and 5 to the output device 30 of the administrator computer 1.

To this end, the management calendar provision unit 170 includes a calendar generator 171, an output reference information generator 172, an information display unit 173, a total information display unit 174, a first difference information generator 175, and a second difference information generator 176.

Here, as shown in FIGS. 4 and 5, the calendar generator 171 generates the financial information management calendar including a plurality of date fields composed of a date display area and an information display area, and a total information field having a monthly total information display area about the first automatic generation type financial information.

Next, the output reference information generator 172 generates output reference information that determines whether to display difference information based on the slip date or whether to display difference information based on the deposit/withdrawal transaction dates based the signal input by the input device 20 of the administrator computer 1 to set a calendar output display reference.

According to an embodiment, the output reference information generator 172 may also generate output reference information that determines whether the reference of information to be displayed in the information display area in the plurality of date fields of the calendar the monthly total information display area in the total information field is applied to all of preset bank accounts or applied to only a specific bank account alone.

Next, the information display unit 173 displays detailed information about the total withdrawal amount, the total deposit amount, and the balance after transaction on a daily basis of the pieces of the first automatic generation type slip information including the information about the transaction date corresponding to the date displayed in the date display area in each of the information display area in the plurality of date fields based on the first automatic generation type slip information generated through the automatic generation type slip information generator 140.

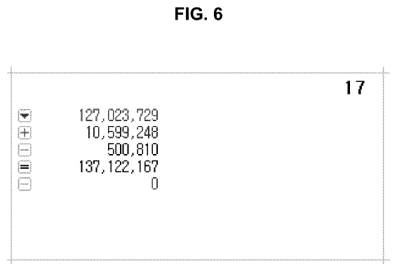

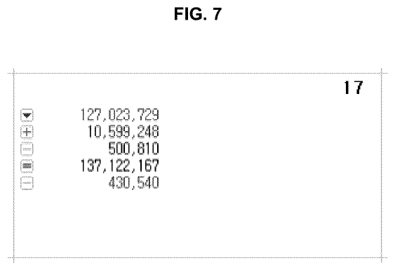

Specifically, as shown in FIGS. 6 and 7, the details about a previous day's balance, today's income, today's expenditure, and today's balance of the preset and linked bank account are converted into formation and displayed in each of the information display area in the plurality of date fields through the information display unit 173 as shown in FIGS. 6 and 7, and in this case, each information is provided to be displayed in a different color to be easily distinguished and identified.

Furthermore, as shown in FIGS. 6 and 7, the information about the comparison difference between the first automatic generation type slip information and the input generation type slip information is also reflected additionally in each of the information display area in the plurality of date fields through the information display unit 173.

In this regard, the first difference information generator 175 generates primary difference information about a comparison difference between a balance by transaction date of each band account calculated by details of a total withdrawal amount and a total deposit amount by transaction date of the pieces of the first automatic generation type slip information generated through the automatic generation type slip information generator 140 and a balance by slip date of each bank account calculated by details of a total withdrawal amount and a total deposit amount by slip date of the pieces of the input generation type slip information generated through the input generation type slip information generator 150.

In this regard, the second difference information generator 176 generates secondary difference information about a comparison difference between a balance by transaction date of each band account calculated by details of a total withdrawal amount and a total deposit amount by transaction date of the pieces of the first automatic generation type slip information generated through the automatic generation type slip information generator 140 and a balance by slip date of each bank account calculated by details of a total withdrawal amount and a total deposit amount by slip date of the pieces of the input generation type slip information generated through the input generation type slip information generator 150.

According to an embodiment, since the primary difference information generated through the primary difference information generator 175 may be reflected through the third slip information output unit 183 in the difference comparison platform provided by the ERP program installed on the administrator computer 1 to allow the balance by transaction date of each bank account calculated by the details of the total withdrawal amount and the total deposit amount by transaction date of the pieces of the first automatic generation type slip information to be displayed in the area partitioned into Financial information A, allow the details of the total withdrawal amount and the total deposit amount by slip date of the pieces of the input generation type slip information to be displayed in a portion partitioned into ERP information B, and allow the comparison difference of the balance by slip date of each bank account to be displayed in a portion partitioned in to Difference (A-B), the administrator can recognize and compare the corresponding information to quickly check errors of the slip matching, thereby preventing financial accidents and furthermore, quickly and specifically analyze information.

Therefore, when the output reference information for displaying difference information based on the slip date is generated through the output reference information generator 172, as shown in FIG. 5, the information display unit 173 displays the primary difference information at the date corresponding to the date displayed in the date display area in each of the information display area in the plurality of date fields.

In addition, when the output reference information for displaying difference information based on deposit and withdrawal dates is generated through the output reference information generator 172, as shown in FIG. 4, the information display unit 173 displays the secondary difference information at the date corresponding to the date displayed in the date display area in each of the information display area in the plurality of date fields.

Therefore, as shown in FIG. 6, when the secondary difference information at the date corresponding to the date displayed in the date display area is displayed in each of the information display area in the plurality of date fields of the calendar, it is normal that the secondary difference information is displayed as 0 won, but when an error is present on the automatic or manual slip registration, the displayed difference according to the secondary difference information is displayed as a specific amount to allow the administrator to quickly identify an error situation, thereby easily preventing financial accidents accordingly.

In addition, as shown in FIG. 7, when the primary difference information at the date corresponding to the date displayed in the date display area is displayed in each of the information display area in the plurality of date fields of the calendar, the comparison difference may be displayed on the specific amount in some cases due to the limitation of the working time during which the administrator may directly and manually input and generate the slip information based on the slip date.

Lastly, the total information display unit 174 displays comprehensive information about the total withdrawal amount, the total deposit amount, and the balance after transaction on a monthly basis in the monthly total information display area in the total information field as shown in FIGS. 4 and 5 based on the pieces of the first automatic generation type slip information displayed on each of the plurality of date fields.

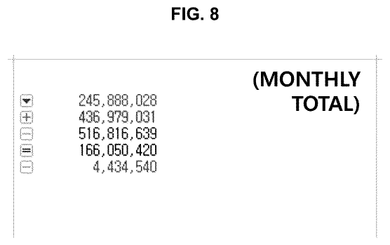

Furthermore, as shown in FIG. 8, the total information display unit 174 also displays the comprehensive information about the total amount of the comparison difference on a monthly basis in the monthly total information display area in the total information field based on the pieces of the primary difference information and the pieces of the secondary difference information that are display in each of the plurality of date fields through the information display unit 173.

The embodiments disclosed in the present invention are not intended to limit the technical spirit of the present invention, but intended to describe the same, and the scope of the technical spirit of the present invention is not limited by the embodiments. The scope should be construed by the appended claims, and all technical spirits within the equivalent range should be construed as being included in the scope of the present invention.

### DESCRIPTION OF REFERENCE NUMERALS

1: administrator computer
10: memory device, 20: input device, 30: output device
40: calculation device, 50: control device
100: wage statement management system
110: first financial information collector 120: second financial information collector
130: third financial information collector 140: automatic generation type slip information generator
150: input generation type slip information generator
160: slip information matching unit
161: first customer name work processor
162: second customer name work processor
163: slip information automatic matcher
164: first slip information manual matcher
165: second slip information manual matcher
166: combination information storage 167: comparison information generator
170: financial information management calendar provision unit
171: calendar generator
172: output reference information generator 173: information display unit
174: total information display unit 175: primary difference information generator
176: secondary difference information generator
180: slip information output unit
181: first slip information output unit 182: second slip information output unit
183: third slip information output unit

1. A comprehensive financial management system provided by an enterprise resource planning (ERP) program installable on an administrator computer, comprising:
a first financial information collector configured to receive first financial information about deposit and withdrawal details for each preset account from a bank server preset and linked to receive information and convert the first financial information into a database;
a second financial information collector configured to receive second financial information about approval details for each preset card from a card company server preset and linked to receive information and convert the second financial information into a database;
a third financial information collector configured to receive third financial information about details of electronic tax invoices, electronic invoices, and cash receipts that are supplied or received based on a pre-set management business operator from the National Tax Service server preset and linked to receive information and convert the third financial information into a database;
an automatic generation type slip information generator configured to generate first automatic generation type slip information including information about a transaction amount and a balance after transaction corresponding to one of a bank name, an account number, a transaction date, a transaction time, a customer name, a withdrawal amount, or deposit amount based on the first financial information collected through the first financial information collector, generate second automatic generation type slip information including information about a transaction date, a customer name, a business registration number, and an approval amount based on the second financial information collected through the second financial information collector, generate third automatic generation type slip information including information about an invoice issuance date, a customer name, a business registration number, and a total amount based on the third financial information about details of electronic tax invoices collected through the third financial information collector, generate fourth automatic generation type slip information including information about an invoice issuance date, a customer name, a business registration number, and a total amount based on the third financial information about the details of the electronic tax invoices collected through the third financial information collector, and generate fifth automatic generation type slip information including information about a cash receipt date, a customer name, a business registration number, and a purchase amount based on the third financial information about details of cash receipts collected through the third financial information collector;
an input generation type slip information generator configured to generate input generation type slip information including information about a first slip type corresponding to one of income or expenditure, a slip date, a payment method, a second slip type classified according to a tax type, a customer name, a transaction amount corresponding to one of income or expenditure, deposit and withdrawal transaction dates, an account subject, a construction name, a site name, and a summary based on a signal input by an input device of the administrator computer;
a slip information matching unit configured to perform a matching operation for pieces of slip information in which pieces of information about customer names in a preset period are matched in each of a first slip type between the input generation type slip information in which the payment method by the second slip type among the first automatic generation type slip information and the input generation type slip information is an item related to bank transaction, a second slip type between the input generation type slip information in which the payment method by the second slip type among the second automatic generation type slip information and the input generation type slip information is an item related to card payment, a third slip type between the input generation type slip information in which the tax type by the second slip type among the third automatic generation type slip information and the input generation type slip information is an item related to an electronic tax invoice, a fourth slip type between the input generation type slip information in which the tax type by the second slip type among the fourth automatic generation type slip information and the input generation type slip information is an item related to an electronic invoice, and a fifth slip type between the input generation type slip information in which the tax type by the second slip type among the fifth automatic generation type slip information and the input generation type slip information is an item related to the cash receipt; and
a financial information management calendar provision unit configured to output and provide a calendar displayed to allow the first automatic generation type slip information generated through the automatic generation type slip information corresponds to a transaction date in the first automatic generation type slip information by date in the calendar to an output device of the administrator computer.

2. The comprehensive financial management system of claim 1, wherein the slip information matching unit includes:
a first customer name word processor configured to perform word processing that connects all letters by ignoring a spacing of each of the customer name included in the first automatic generation type slip information to the fifth automatic generation type slip information generated through the automatic generation type slip information generator and the customer name included in the input generation type slip information generated through the input generation type slip information generator;
a second customer name word processor configured to perform word processing that excludes letters of Co., Ltd., Co., Ltd., (solidarity), general partnership, (limited), limited company, (company), incorporated association, (foundation), incorporated foundation, (agricultural), and agricultural corporation from each of the customer names whose spacing has been ignored through the first customer name word processor; and
a slip information automatic matcher configured to match the first automatic generation type slip information to the fifth automatic generation type slip information with the input generation type slip information each of which consecutive identical letters are a preset matching reference number or more based on each of the customer name whose specific letters have been excluded through the second customer name word processor 162 and perform information processing separately according to the number of slips matched, and
as a case where the number of slips matched as the result of matching is 1, the slip information automatic matcher generates matching end slip information by pairing a pair of one of the first automatic generation type slip information to the fifth automatic generation type slip information and one of the input generation type slip information, which are matched as 1:1.

3. The comprehensive financial management system of claim 2, wherein, as a case where the number of slips matched as the result of matching is 2 or more, the slip information automatic matcher generates first manual matching slip information by pairing a plurality of pieces of information in which a plurality of pieces of the first automatic generation type slip information to the fifth automatic generation type slip information and one of the input generation type slip information are matched or one of the first automatic generation type slip information to the fifth automatic generation type slip information and a plurality of pieces of the input generation type slip information are matched, and
the slip information matching unit further includes a first slip information manual matcher configured to convert paired information into the matching end slip information by pairing the pair of one corresponding to a matching target selection signal of the first automatic generation type slip information to the fifth automatic generation type slip information and one corresponding to the matching target selection signal of the input generation type slip information in the first manual matching slip information based on the matching target selection signal input by the input device of the administrator computer, which are matched as 1:1.

4. The comprehensive financial management system of claim 2, wherein, as a case where the number of slips matched as the result of matching is zero, the slip information automatic matcher does not match the first automatic generation type slip information to the fifth automatic generation type slip information and the input generation type slip information, but generates second manual matching slip information by pairing a pair of one of the first automatic generation type slip information to the fifth automatic generation type slip information and one of the input generation type slip information, which are matched as 1:1, in which information about the amount corresponding to one of the transaction amount, the approval amount, the total amount, or the purchase amount included in the first automatic generation type slip information to the fifth automatic generation type slip information matches the information about the transaction amount included in the input generation type slip information,
the slip information matching unit further includes:
a second slip information manual matcher configured to convert second manual matching slip information corresponding a matching approval signal into the matching end slip information based on the matching approval signal input by the input device of the administrator computer; and
a combination information storage configured to generate and store, as matchable customer name combination information, a customer name included in one of the first automatic generation type slip information to the fifth automatic generation type slip information and a customer name included in one of the input generation type slip information, which correspond to information target generated by being converted into the matching end slip information from the second manual matching slip information through the second slip information manual matcher, and
even when consecutive identical letters are not the preset matching reference number or more based on each customer name whose specific letters are excluded through the second customer name word processor, the slip information automatic matcher generates the matching end slip information by pairing the pair of one of the first automatic generation type slip information to the fifth automatic generation type slip information and one of the input generation type slip information, which are matched as 1:1, each including the information about the customer name corresponding to the matchable customer name combination information stored in the combination information storage.

5. The comprehensive financial management system of claim 2, wherein the slip information matching unit further includes a comparison information generator configured to generate comparison information including information about a comparison difference of the total amount of the input generation type slip information that does not match the individual amount of each of the automatic generation type slip information not matched by slip type, the total amount of the automatic generation type slip information, the individual transaction amount of each of the input generation type slip information not matched by slip type, the total amount of the input generation type slip information not matched by slip type, and the total amount of the automatic generation type slip information not matched by slip type based on information about the amount corresponding to one of the transaction amount, the approval amount, the total amount, or the purchase amount included in the first automatic generation type slip information to the fifth automatic generation type slip information and information about the transaction amount included in the input generation type slip information, which correspond to a case where the number of slips matched as the result of matching through the slip information automatic matcher is zero.

6. The comprehensive financial management system of claim 1, wherein the financial information management calendar provision unit further includes:
a calendar generator configured to generate a financial information management calendar including a plurality of date fields composed of a date display area and an information display area and a total information field having a monthly total information display area for the first automatic generation type slip information;
an information display unit configured to display detailed information about the total withdrawal amount, the total deposit amount, and the balance after transaction on a daily basis of the pieces of the first automatic generation type slip information including the information about the transaction date corresponding to the date displayed in the date display area in each of the information display area in the plurality of date fields based on the first automatic generation type slip information generated through the automatic generation type slip information generator;
a total information display unit configured to display comprehensive information about a total withdrawal amount, a total deposit amount, and a balance after transaction on a monthly basis in the monthly total information display area in the total information field based on the pieces of the first automatic generation type slip information displayed in each of the plurality of date fields through the information display unit;
a first difference information generator configured to generate primary difference information about a comparison difference between a balance by transaction date of each band account calculated by details of a total withdrawal amount and a total deposit amount by transaction date of the pieces of the first automatic generation type slip information generated through the automatic generation type slip information generator and a balance by slip date of each bank account calculated by details of a total withdrawal amount and a total deposit amount by slip date of the pieces of the input generation type slip information generated through the input generation type slip information generator;
a second difference information generator configured to generate secondary difference information about a comparison difference between a balance by transaction date of each band account calculated by details of a total withdrawal amount and a total deposit amount by transaction date of the pieces of the first automatic generation type slip information generated through the automatic generation type slip information generator and a balance by slip date of each bank account calculated by details of a total withdrawal amount and a total deposit amount by slip date of the pieces of the input generation type slip information generated through the input generation type slip information generator; and
an output reference information generator configured to generate output reference information that determines whether to display difference information based on the slip date or whether to display difference information based on the deposit/withdrawal transaction dates based the signal input by the input device of the administrator computer to set a calendar output display reference,
when the output reference information for displaying difference information based on the slip date is generated through the output reference information generator, the information display unit displays primary difference information at a date corresponding to the date displayed in the date display area in each of the information display area in the plurality of date fields, and
when the output reference information for displaying difference information based on deposit and withdrawal dates is generated through the output reference information generator, the information display unit displays secondary difference information at a date corresponding to the date displayed in the date display area in each of the information display area in the plurality of date fields.
